(19) United States
(12) Patent Application Publication
(10) Pub. No.: US 2026/0275840 A1
(43) Pub. Date: Sep. 17, 2026

(54) SYSTEMS AND METHODS FOR PROCESSING SEISMIC DATA

(71) Applicant: Schlumberger Technology Corporation, Sugar Land, TX (US)

(72) Inventors: Yantao Luo, Houston, TX (US); Ran Bachrach, Houston, TX (US)

(21) Appl. No.: 19/554,854

(22) Filed: Mar. 3, 2026

Related U.S. Application Data
(60) Provisional application No. 63/770,416, filed on Mar. 12, 2025.

(51) Int. Cl. E21B 43/16; G01V 1/50

(52) U.S. Cl. CPC E21B 43/16; G01V 1/50; E21B 2200/22

(57) ABSTRACT

A method for training a machine-learning (ML) model processing seismic data may include obtaining input data including a target dataset and user-defined inputs. The target dataset may include the seismic data. The method may also include generating a synthetic dataset including synthetic seismic data based on the seismic data of the target datasets. The method may further include generating a ground-truth dataset based on the synthetic dataset and the user-defined inputs. The method may also include generating one or more training pairs based on the ground-truth dataset and the synthetic dataset. The method may also include training the machine-learning (ML) model based on the one or more training pairs to generate a trained ML model.

### CROSS-REFERENCE TO RELATED APPLICATIONS

This application claims priority to and the benefit of U.S. Provisional Patent Application No. 63/770,416 filed on Mar. 12, 2025, the entirety of which is incorporated herein by reference to the extent consistent with the present disclosure.

### BACKGROUND

Conventional workflows for processing seismic data often include filtering unwanted noise, such as unwanted coherent noise. Coherent noise, such as high-amplitude ground roll in land acquisitions, may obscure lower-amplitude reflection events, thereby degrading subsequent processing and imaging quality. Conventional coherent-noise attenuation commonly relies on dip filtering in the frequency-wavenumber (f-k) domain or the frequency-space (f-x) domain. These approaches, however, may not eliminate aliased noise and may struggle to separate events having similar dips in the f-k domain, particularly at low frequencies. Such limitations are more pronounced for Surface Distributed Acoustic Sensing (S-DAS) datasets, which are richer in low-frequency content than traditional three-component (3C) data. In addition, due to the unidirectional sensing characteristics of DAS, ground roll may be recorded with substantially higher fidelity than reflection energy at near offsets, increasing amplitude disparities in the record and further complicating attenuation using traditional f-x/f-k filtering techniques.

More recently, machine learning (ML) approaches have been proposed to improve coherent-noise filtering, with the goals of enhancing dip/velocity discrimination and preserving reflection amplitudes. These ML approaches employ semi-supervised or unsupervised learning to reduce dependence on ground-truth labels. While supervised learning may be attractive for learning direct mappings between noisy and noise-attenuated representations, practical deployment is often constrained by the limited availability of labeled field datasets and by the difficulty of generating synthetic datasets that are sufficiently comprehensive to capture field variability, acquisition conditions, and noise characteristics.

What is needed, then, are systems and methods for processing seismic data.

### SUMMARY

A method for training a machine-learning (ML) model for processing seismic data is disclosed. The method may include obtaining input data including a target dataset and user-defined inputs. The target dataset may include the seismic data. The method may also include generating a synthetic dataset including synthetic seismic data based on the seismic data of the target datasets. The method may further include generating a ground-truth dataset based on the synthetic dataset and the user-defined inputs. The method may also include generating one or more training pairs based on the ground-truth dataset and the synthetic dataset. The method may also include training the machine-learning (ML) model based on the one or more training pairs to generate a trained ML model.

A computing system is also disclosed. The computing system includes one or more processors and a memory system. The memory system includes one or more non-transitory computer-readable media storing instructions that, when executed by at least one of the one or more processors, cause the computing system to perform operations for training a machine-learning (ML) model for processing seismic data. The operations include obtaining input data including a target dataset and user-defined inputs. The target dataset includes the seismic data. The operations also include generating a synthetic dataset including synthetic seismic data based on the seismic data of the target datasets. The operations further include generating a ground-truth dataset based on the synthetic dataset and the user-defined inputs. The operations also include generating one or more training pairs based on the ground-truth dataset and the synthetic dataset. The operations also include training the machine-learning (ML) model based on the one or more training pairs to generate a trained ML model.

A non-transitory computer-readable medium is also disclosed. The medium stores instructions that, when executed by one or more processors of a computing system, cause the computing system to perform operations for training a machine-learning (ML) model for processing seismic data. The operations include obtaining input data including a target dataset and user-defined inputs. The target dataset includes the seismic data. The operations also include generating a synthetic dataset including synthetic seismic data based on the seismic data of the target datasets. The operations further include generating a ground-truth dataset based on the synthetic dataset and the user-defined inputs. The operations also include generating one or more training pairs based on the ground-truth dataset and the synthetic dataset. The operations also include training the machine-learning (ML) model based on the one or more training pairs to generate a trained ML model.

It will be appreciated that this summary is intended merely to introduce some aspects of the present methods, systems, and media, which are more fully described and/or claimed below. Accordingly, this summary is not intended to be limiting.

### BRIEF DESCRIPTION OF THE DRAWINGS

The accompanying drawings, which are incorporated in and constitute a part of this specification, illustrate embodiments of the present teachings and together with the description, serve to explain the principles of the present teachings. In the figures:

FIG. 1 illustrates an example of a system that includes various management components to manage various aspects of a geologic environment, according to an embodiment.

FIG. 2 illustrates exemplary synthetically generated images for training and validating the ML model, according to an embodiment.

FIG. 3 illustrates respective F-k spectra of the synthetically generated images of FIG. 2, according to an embodiment.

FIG. 4 illustrates a comparison of outputs generated from the ML dip filter and a conventional f-x domain filter, according to an embodiment.

FIG. 5 illustrates a flowchart of a method for processing seismic data, according to an embodiment.

FIG. 6 illustrates a schematic view of a computing system for performing at least a portion of the method(s) described herein, according to an embodiment.

### DETAILED DESCRIPTION

Reference will now be made in detail to embodiments, examples of which are illustrated in the accompanying drawings and figures. In the following detailed description, numerous specific details are set forth in order to provide a thorough understanding of the present disclosure. However, it will be apparent to one of ordinary skill in the art that the present disclosure may be practiced without these specific details. In other instances, well-known methods, procedures, components, circuits, and networks have not been described in detail so as not to unnecessarily obscure aspects of the embodiments.

It will also be understood that, although the terms first, second, etc. may be used herein to describe various elements, these elements should not be limited by these terms. These terms are only used to distinguish one element from another. For example, a first object or step could be termed a second object or step, and, similarly, a second object or step could be termed a first object or step, without departing from the scope of the present disclosure. The first object or step, and the second object or step, are both, objects or steps, respectively, but they are not to be considered the same object or step.

The terminology used in the description herein is for the purpose of describing particular embodiments and is not intended to be limiting. As used in this description and the appended claims, the singular forms “a,” “an” and “the” are intended to include the plural forms as well, unless the context clearly indicates otherwise. It will also be understood that the term “and/or” as used herein refers to and encompasses any possible combinations of one or more of the associated listed items. It will be further understood that the terms “includes,” “including,” “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Further, as used herein, the term “if”′ may be construed to mean “when” or “upon” or “in response to determining” or “in response to detecting,” depending on the context.

Attention is now directed to processing procedures, methods, techniques, and workflows that are in accordance with some embodiments. Some operations in the processing procedures, methods, techniques, and workflows disclosed herein may be combined and/or the order of some operations may be changed.

### System Overview

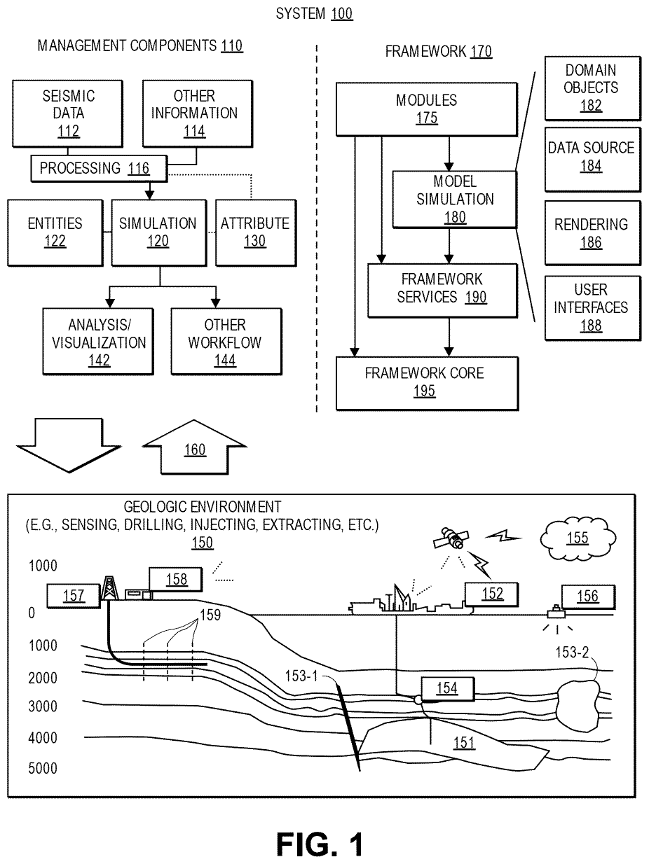

FIG. 1 illustrates an example of a system 100 that includes various management components 110 to manage various aspects of a geologic environment 150 (e.g., an environment that includes a sedimentary basin, a reservoir 151, one or more faults 153-1, one or more geobodies 153-2, etc.). For example, the management components 110 may allow for direct or indirect management of sensing, drilling, injecting, extracting, etc., with respect to the geologic environment 150. In turn, further information about the geologic environment 150 may become available as feedback 160 (e.g., optionally as input to one or more of the management components 110).

In the example of FIG. 1, the management components 110 include a seismic data component 112, an additional information component 114 (e.g., well/logging data), a processing component 116, a simulation component 120, an attribute component 130, an analysis/visualization component 142 and a workflow component 144. In operation, seismic data and other information provided per the components 112 and 114 may be input to the simulation component 120.

In an example embodiment, the simulation component 120 may rely on entities 122. Entities 122 may include earth entities or geological objects such as wells, surfaces, bodies, reservoirs, etc. In the system 100, the entities 122 may include virtual representations of actual physical entities that are reconstructed for purposes of simulation. The entities 122 may include entities based on data acquired via sensing, observation, etc. (e.g., the seismic data 112 and other information 114). An entity may be characterized by one or more properties (e.g., a geometrical pillar grid entity of an earth model may be characterized by a porosity property). Such properties may represent one or more measurements (e.g., acquired data), calculations, etc.

In an example embodiment, the simulation component 120 may operate in conjunction with a software framework such as an object-based framework. In such a framework, entities may include entities based on pre-defined classes to facilitate modeling and simulation. A commercially available example of an object-based framework is the MICROSOFT® NET® framework (Redmond, Washington), which provides a set of extensible object classes. In the .NET® framework, an object class encapsulates a module of reusable code and associated data structures. Object classes may be used to instantiate object instances for use in by a program, script, etc. For example, borehole classes may define objects for representing boreholes based on well data.

In the example of FIG. 1, the simulation component 120 may process information to conform to one or more attributes specified by the attribute component 130, which may include a library of attributes. Such processing may occur prior to input to the simulation component 120 (e.g., consider the processing component 116). As an example, the simulation component 120 may perform operations on input information based on one or more attributes specified by the attribute component 130. In an example embodiment, the simulation component 120 may construct one or more models of the geologic environment 150, which may be relied on to simulate behavior of the geologic environment 150 (e.g., responsive to one or more acts, whether natural or artificial). In the example of FIG. 1, the analysis/visualization component 142 may allow for interaction with a model or model-based results (e.g., simulation results, etc.). As an example, output from the simulation component 120 may be input to one or more other workflows, as indicated by a workflow component 144.

As an example, the simulation component 120 may include one or more features of a simulator such as the ECLIPSE™ reservoir simulator (SLB, Houston Texas), the INTERSECT™ reservoir simulator (SLB, Houston Texas), etc. As an example, a simulation component, a simulator, etc. may include features to implement one or more meshless techniques (e.g., to solve one or more equations, etc.). As an example, a reservoir or reservoirs may be simulated with respect to one or more enhanced recovery techniques (e.g., consider a thermal process such as SAGD, etc.).

As an example, the simulation component 120 may include one or more features of a simulator such as SYMMETRY™ software (SLB, Houston, Texas). More particularly, SYMMETRY™ may process workflows in a single integrated environment with accurate thermodynamic fluid representation and consistent modeling across multiple disciplines including process, production, and HSE. The simulator integrates steady-state and transient (e.g., dynamic) analyses that may be tailored for each domain. This approach enables users to optimize processes in upstream, midstream, and downstream sectors while maximizing profits and minimizing capital expenditures. It may also help reduce emissions, energy consumption, and waste.

As an example, the simulation component 120 may include one or more features of a simulator such as PIPESIM™ (SLB, Houston, Texas). More particularly, PIPESIM™ is steady-state multiphase flow simulator that incorporates the three areas of flow modeling: multiphase flow, heat transfer and fluid behavior.

As an example, the simulation component 120 may include one or more features of a simulator such as OLGA™ (SLB, Houston, Texas). More particularly, OLGA™ is a dynamic multiphase flow simulator that models transient flow (e.g., time-dependent behaviors) to maximize production potential. Transient modeling is a component for feasibility studies and field development design. Dynamic simulation is useful in deep water and is used in both offshore and onshore developments to investigate transient behavior in pipelines and wellbores. Transient simulation with the OLGA™ simulator provides an added dimension to steady-state analysis by predicting system dynamics, such as time-varying changes in flow rates, fluid compositions, temperature, solids deposition, and operational changes.

In an example embodiment, the management components 110 may include features of a commercially available framework such as the PETREL® seismic to simulation software framework (SLB, Houston, Texas). The PETREL® framework provides components that allow for optimization of exploration and development operations. The PETREL® framework includes seismic to simulation software components that may output information for use in increasing reservoir performance, for example, by improving asset team productivity. Through use of such a framework, various professionals (e.g., geophysicists, geologists, and reservoir engineers) may develop collaborative workflows and integrate operations to streamline processes. Such a framework may be considered an application and may be considered a data-driven application (e.g., where data is input for purposes of modeling, simulating, etc.).

In an example embodiment, various aspects of the management components 110 may include add-ons or plug-ins that operate according to specifications of a framework environment. For example, a commercially available framework environment marketed as the OCEAN® framework environment (SLB, Houston, Texas) allows for integration of add-ons (or plug-ins) into a PETREL® framework workflow. The OCEAN® framework environment leverages .NET® tools (Microsoft Corporation, Redmond, Washington) and offers stable, user-friendly interfaces for efficient development. In an example embodiment, various components may be implemented as add-ons (or plug-ins) that conform to and operate according to specifications of a framework environment (e.g., according to application programming interface (API) specifications, etc.).

FIG. 1 also shows an example of a framework 170 that includes a model simulation layer 180 along with a framework services layer 190, a framework core layer 195 and a modules layer 175. The framework 170 may include the commercially available OCEAN® framework where the model simulation layer 180 is the commercially available PETREL® model-centric software package that hosts OCEAN® framework applications. In an example embodiment, the PETREL® software may be considered a data-driven application. The PETREL® software may include a framework for model building and visualization.

As an example, a framework may include features for implementing one or more mesh generation techniques. For example, a framework may include an input component for receipt of information from interpretation of seismic data, one or more attributes based at least in part on seismic data, log data, image data, etc. Such a framework may include a mesh generation component that processes input information, optionally in conjunction with other information, to generate a mesh.

In the example of FIG. 1, the model simulation layer 180 may provide domain objects 182, act as a data source 184, provide for rendering 186 and provide for various user interfaces 188. Rendering 186 may provide a graphical environment in which applications may display their data while the user interfaces 188 may provide a common look and feel for application user interface components.

As an example, the domain objects 182 may include entity objects, property objects and optionally other objects. Entity objects may be used to geometrically represent wells, surfaces, bodies, reservoirs, etc., while property objects may be used to provide property values as well as data versions and display parameters. For example, an entity object may represent a well where a property object provides log information as well as version information and display information (e.g., to display the well as part of a model).

In the example of FIG. 1, data may be stored in one or more data sources (or data stores, generally physical data storage devices), which may be at the same or different physical sites and accessible via one or more networks. The model simulation layer 180 may be configured to model projects. As such, a particular project may be stored where stored project information may include inputs, models, results and cases. Thus, upon completion of a modeling session, a user may store a project. At a later time, the project may be accessed and restored using the model simulation layer 180, which may recreate instances of the relevant domain objects.

In the example of FIG. 1, the geologic environment 150 may include layers (e.g., stratification) that include a reservoir 151 and one or more other features such as the fault 153-1, the geobody 153-2, etc. As an example, the geologic environment 150 may be outfitted with any of a variety of sensors, detectors, actuators, etc. For example, equipment 152 may include communication circuitry to receive and to transmit information with respect to one or more networks 155. Such information may include information associated with downhole equipment 154, which may be equipment to acquire information, to assist with resource recovery, etc. Other equipment 156 may be located remote from a well site and include sensing, detecting, emitting or other circuitry. Such equipment may include storage and communication circuitry to store and to communicate data, instructions, etc. As an example, one or more satellites may be provided for purposes of communications, data acquisition, etc. For example, FIG. 1 shows a satellite in communication with the network 155 that may be configured for communications, noting that the satellite may additionally or instead include circuitry for imagery (e.g., spatial, spectral, temporal, radiometric, etc.).

FIG. 1 also shows the geologic environment 150 as optionally including equipment 157 and 158 associated with a well that includes a substantially horizontal portion that may intersect with one or more fractures 159. For example, consider a well in a shale formation that may include natural fractures, artificial fractures (e.g., hydraulic fractures) or a combination of natural and artificial fractures. As an example, a well may be drilled for a reservoir that is laterally extensive. In such an example, lateral variations in properties, stresses, etc. may exist where an assessment of such variations may assist with planning, operations, etc. to develop a laterally extensive reservoir (e.g., via fracturing, injecting, extracting, etc.). As an example, the equipment 157 and/or 158 may include components, a system, systems, etc. for fracturing, seismic sensing, analysis of seismic data, assessment of one or more fractures, etc.

As mentioned, the system 100 may be used to perform one or more workflows. A workflow may be a process that includes a number of worksteps. A workstep may operate on data, for example, to create new data, to update existing data, etc. As an example, a workstep may operate on one or more inputs and create one or more results, for example, based on one or more algorithms. As an example, a system may include a workflow editor for creation, editing, executing, etc. of a workflow. In such an example, the workflow editor may provide for selection of one or more pre-defined worksteps, one or more customized worksteps, etc. As an example, a workflow may be a workflow implementable in the PETREL® software, for example, that operates on seismic data, seismic attribute(s), etc. As an example, a workflow may be a process implementable in the OCEAN® framework. As an example, a workflow may include one or more worksteps that access a module such as a plug-in (e.g., external executable code, etc.).

The present disclosure is directed to a machine-learning (ML) x-t domain dip filtering method, methodology, or workflow including supervised machine-learning. The method incorporates an automated and efficient approach to generate a relatively large amount of synthetic data covering a wide range of scenarios and/or events encountered in field datasets. The disclosed ML x-t domain dip filtering method may be used as an alternative to traditional f-k or f-x domain filters. The disclosed ML x-t domain dip filtering method exhibits or demonstrates improved performance, especially when there is aliasing and/or when there is a relatively high value in the amplitude fidelity and the velocity resolution. The method may be implemented in Python and may be used in Omega, a geophysical/seismic data processing platform of SLB N.V., via Pythonlink or PyLaunch SFMs.

As further described herein, the method separates events with varying or different dips directly in the x-t domain instead of defining pass/reject fans in the f-k domain. The ML dip filter or the ML model is trained on automatically generated comprehensive synthetic datasets that contain events with relatively similar dips and/or drastically different amplitudes such that the ML model learns to function properly in these scenarios where traditional or conventional filters may be insufficient. The methods disclosed herein may be used to extract relatively weak reflections from surface distributed acoustic sensing (S-DAS) datasets including ground roll (e.g., relatively strong ground roll). The methods disclosed herein may also be utilized to remove aliased energy from less densely sampled datasets. The methods disclosed herein may further be utilized for mode separation tasks that utilize high fidelity (e.g., separating PP and PS waves in the data/datasets).

The dip filtering may be performed in the x-t domain and may be treated as a computer vision task. The computer vision task may include inputting a picture or image (e.g., seismic image) including a plurality of events (e.g., linear events, hyperbolic events, etc.), where a horizontal axis (e.g., x-axis) of the seismic image may be space and a vertical axis (e.g., y-axis) of the seismic image may be time. The computer vision task may also include retaining one or more of the plurality of events within a predetermined dip/velocity range. The method may include generating a training dataset. The training dataset may include one or more pairs of images or seismic images. The method may include training a machine-learning (ML) model based on the training dataset. The inputs or the training dataset for the ML model may be or include, but is not limited to, one or more images with varying kinds/types of dips, one or more ground-truth or ground-truth images including dips within the predetermined range. The respective size and respective resolution of these images may be determined or defined by the respective spatial sampling and the respective temporal sampling of a target dataset, thereby ensuring a sufficiently low Rayleigh frequency and a sufficiently high Nyquist frequency. For each input image of the training dataset, a random number of linear events may be generated. Each event may be a wavelet (e.g., a Ricker wavelet) with a random amplitude and/or a random central frequency. Each event or wavelet may be band-passed by a random high-cut frequency and a low-cut frequency. Each event or wavelet may include a moveout created with a random start time and a random velocity. The image may be normalized by a respective root-mean-square of the amplitude thereof. Among the generated events, the events falling within a defined velocity range (e.g., a user-defined velocity range) may be added to a corresponding ground-truth image. Compared with generating synthetic datasets through conventional acoustic/elastic modeling methods, the methods disclosed herein are relatively faster, more straightforward, and encompass a wide range of patterns/scenarios present in the field datasets.

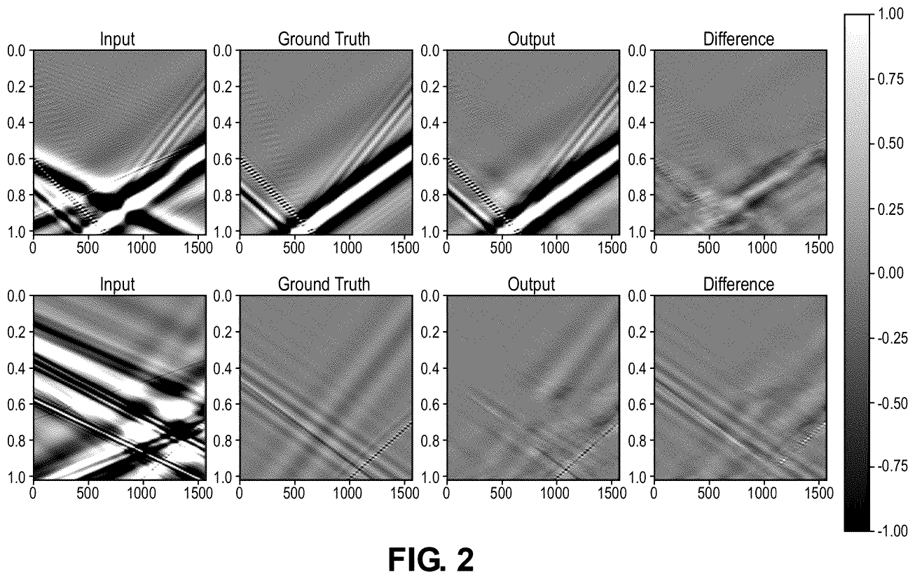

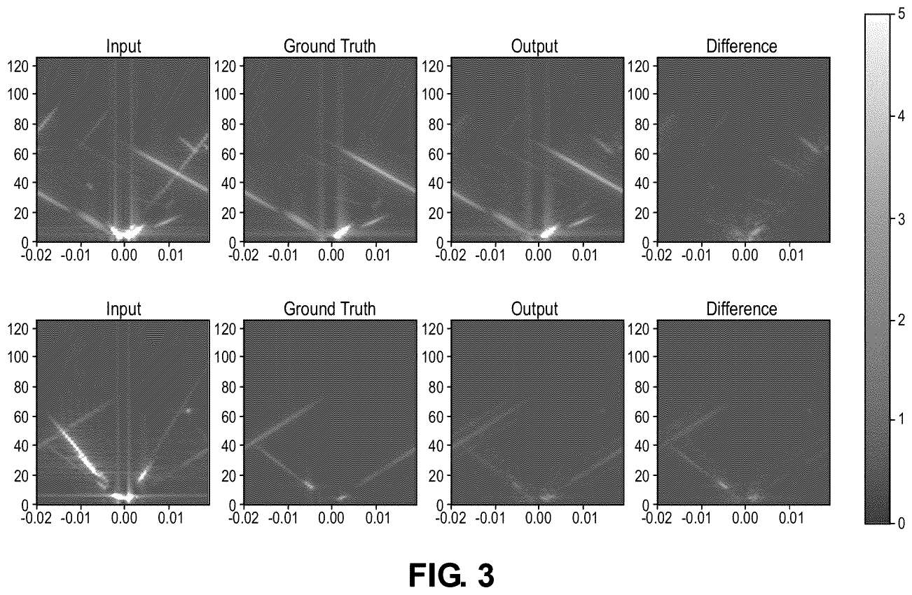

FIG. 2 illustrates exemplary synthetically generated images for training and validating the ML model, according to an embodiment. Each row of FIG. 2 corresponds to a respective example. As illustrated in FIG. 2, the first column illustrates input images, the second column illustrates ground-truth images corresponding to the input images, the third column illustrates output images from the ML model, and the fourth column illustrates differences between the output images and the ground-truth images. The ground-truth images may be generated from the input images. For example, the ground-truth images may include events having a velocity within a predetermined range. For example, the ground-truth images may be generated by filtering out events having a velocity outside the predetermined range, which may, for example, be from about −2,500 m/s to about 2,500 m/s. FIG. 3 illustrates respective F-k spectra of the synthetically generated images of FIG. 2, according to an embodiment.

The ML model may be a U-net-based model. The ML model may be trained to map the input images to the ground-truth images. FIGS. 2 and 3 illustrate the performance of the ML model on a validation set. For example, the F-k spectra illustrated in FIG. 3 shows that the ML model may capture the aliased part of the energy even when the aliased part cuts across signals in the spectra. When applying a trained ML model to the target dataset, each gather may be divided into windows of the same size as the synthetic images used for training the ML model. Each gather may also be normalized before inputting into the ML model. The output images from the ML model may be rescaled and/or reconstructed into the original gather shape. The ML model may be applied in a cascading manner to further remove noise with relatively smaller amplitudes. For example, a first iteration of the output images from the ML model may be utilized as an input in a second iteration to further reduce noise.

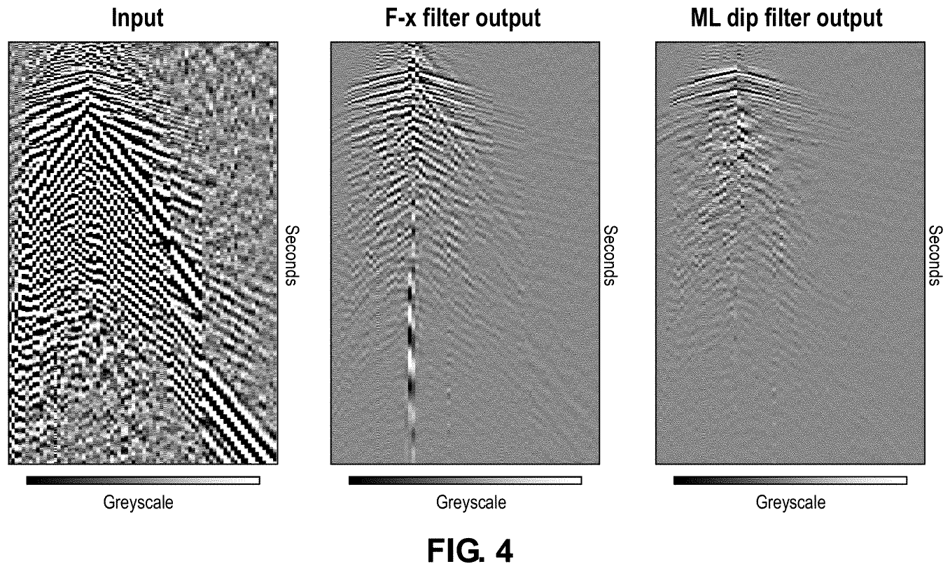

FIG. 4 illustrates a comparison of outputs generated from the ML dip filter of the present disclosure and a conventional f-x domain filter, according to an embodiment. Particularly, FIG. 4 illustrates an input image (first image), an output generated from the conventional f-x domain filter (second image), and an output generated from the trained ML model (e.g., the ML dip filter) of the present disclosure (third image). The input image illustrates a receiver gather before applying any filtering. It should be appreciated that the input image was from a Surface Distributed Acoustic Sensing (S-DAS) dataset from a survey in Texas. The input image illustrates the presence of a relatively strong ground roll in the S-DAS dataset. The ground roll of the input image masks the relatively smaller reflection signals. The traditional f-x dip filter and the trained ML model, or the ML dip filter of the present disclosure, were separately applied to the shot gathers (i.e., the input). The f-x filter output shows the same receiver gather after applying the f-x dip filter with a velocity cutoff of about 7,600 ft/s. The ML dip filter output shows the same receiver gather after applying the trained ML model with a velocity cutoff of about 7,600 ft/s. As illustrated in FIG. 4, the output from the ML dip filter illustrated relatively fewer artifacts (e.g., less remnants of the ground roll energy) and relatively clearer reflection signals, thereby validating the efficacy of the present disclosure.

### Exemplary Method

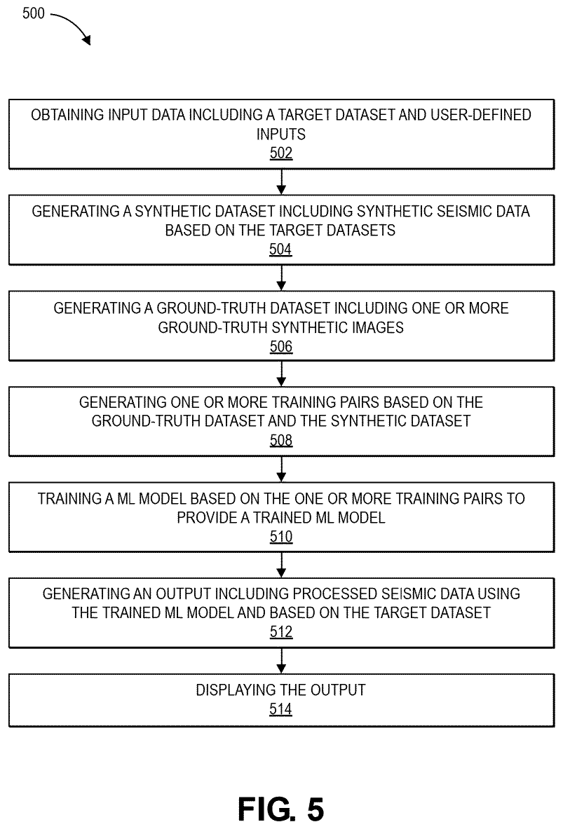

FIG. 5 illustrates a flowchart of a method 500 for processing seismic data, according to an embodiment. For example, the method 500 may be for training a machine-learning (ML) model for processing seismic data. In another example, the method 500 may be for processing the seismic data. An illustrative order of the method 500 is provided below; however, one or more portions of the method 500 may be performed in a different order, simultaneously, repeated, or omitted. At least a portion of the method 500 may be performed using a computing system.

The method 500 may include obtaining input data including a target dataset and user-defined inputs, as at 502. The target dataset may include seismic data. The seismic data may include one or more seismic images. Each seismic image of the one or more seismic images may encode amplitudes of a plurality of seismic traces as a function of a spatial position and time in a multidimensional domain. The spatial position and time may be represented by an x-axis and a y-axis of the multidimensional domain, respectively. Each seismic image of the one or more seismic images may include a respective spatial sampling value or interval, a respective temporal sampling value or interval, a respective time window, or a combination thereof. The user-defined inputs may include a user-defined velocity range. The user-defined velocity range may be from about-2,500 m/s to about 2,500 m/s; however, other ranges are contemplated.

The method 500 may also include generating a synthetic dataset including synthetic seismic data based on the target datasets, as at 504. Generating the synthetic datasets may include generating one or more synthetic images of the synthetic seismic data based on the target datasets. The one or more synthetic images may be based on the seismic data of the target dataset. The one or more synthetic images may be based on the one or more images of the seismic data.

The synthetic seismic data may include one or more synthetic images. A respective size of each synthetic image of the one or more synthetic images may be based on one or more of the respective spatial samplings and the respective temporal sampling of each seismic image of the one or more seismic images. A respective resolution of each synthetic image of the one or more synthetic images may be based on one or more of the respective spatial samplings and the respective temporal sampling of each seismic image of the one or more seismic images. Each synthetic image of the one or more synthetic images may include a respective synthetic time window based on the respective size thereof. Each synthetic image of the one or more synthetic images may include one or more events.

In at least one embodiment, each event of the one or more events may be represented by a respective wavelet. The wavelet of each event of the one or more events may include an amplitude. The amplitude may include a uniform distribution over a logarithmic space having a basis of 10. The amplitude may include a range of from about 0.001 to about 1. The amplitude may include an amplitude variation. The amplitude variation may be a monotonically decreasing amplitude or a monotonically increasing amplitude. There is about a 15% chance the amplitude variation is the monotonically decreasing amplitude. There is about a 15% chance the amplitude variation is the monotonically increasing amplitude. The amplitude may include an increased amplitude or a decreased amplitude at a respective center of the synthetic image of the one or more synthetic images. There is about a 15% chance the amplitude may include the increased amplitude or the decreased amplitude.

In at least one embodiment, the wavelet may include a phase rotation. The phase rotation may include a uniform distribution over a linear space of each synthetic image of the one or more synthetic images. The phase rotation may include a range of from about 0 to about pi (π). The wavelet of each event of the one or more events may be based on a delta function, a Ricker wavelet, or a Gaussian enveloped sinusoidal function. A probability of the wavelet being based on the delta function may be about 30%. A probability of the wavelet being based on the Ricker wavelet may be about 30%. A probability of the wavelet being based on the Gaussian enveloped sinusoidal function may be about 40%.

The Ricker wavelet of each synthetic image of the one or more synthetic images may include a central frequency based on a respective synthetic time window of the synthetic image. The central frequency may be based on the Rayleigh frequency and the Nyquist frequency of the respective synthetic time window of each synthetic image of the one or more synthetic images. A respective range of the central frequency may be based on the Rayleigh frequency and the Nyquist frequency of the respective synthetic time window of each synthetic image of the one or more synthetic images. The central frequency may include a uniform distribution over a respective logarithmic space having a basis of 2.

The Gaussian enveloped sinusoidal function may be based on a combination of a Gaussian function and a sinusoidal function. The Gaussian enveloped sinusoidal function may be a multiplication product of the Gaussian function and the sinusoidal function. The sinusoidal function may include a single frequency based on the Rayleigh frequency and the Nyquist frequency of the respective synthetic time window of each synthetic image of the one or more synthetic images. The sinusoidal function may include a single frequency. The single frequency may include a uniform distribution over a respective logarithmic space having a basis of 2. The Gaussian function may include a standard deviation based on the respective synthetic time window of each synthetic image of the one or more synthetic images. A respective range of the Gaussian function may be from 0 to about ⅛ of the respective synthetic time window of each synthetic image of the one or more synthetic images. A standard deviation of the Gaussian function may include a uniform distribution over a respective linear space of each synthetic image of the one or more synthetic images.

The wavelet may be band-passed by a band-pass range including a low-cut frequency and a high-cut frequency. The low-cut frequency may be randomly generated in a range from the Rayleigh frequency to ½ of the Nyquist frequency of the respective synthetic time window of each synthetic image of the one or more synthetic images. The low-cut frequency may include a uniform distribution over a logarithmic space having a basis of 2. The high-cut frequency may be randomly generated in a range from the low-cut frequency to the Nyquist frequency of the respective synthetic time window of each synthetic image of the one or more synthetic images. The high-cut frequency may include a uniform distribution over a logarithmic space having a basis of 2. The band-pass range may include 100% of the wavelets based on the delta-function. For example, the band-pass may be applied to 100% of the wavelets based on the delta-function. The band-pass range may include about 50% of the wavelets based on the Ricker wavelet. The band-pass range may include about 50% of the wavelets based on the Gaussian enveloped sinusoidal function.

Each event of the one or more events may include a respective reference time, such as a start time (to), and a respective velocity (v). The respective velocity of each event of the one or more events may be based on a dip angle thereof. The dip angle may be from about-89° to about 89°. The dip angle may be randomly drawn from about −89° to about 89°. In one example, about 50% of the respective velocity of each event of the one or more events may be within a user-defined velocity range. The respective reference time of each event of the one or more events may be determined such that the event is visible for at least 20% of a respective time interval of each synthetic image of the one or more synthetic images.

Each event of the one or more events may include a linear moveout or a hyperbolic moveout. For example, each event of the one or more events may be a linear event or a hyperbolic event. The linear event may be represented by formula (1):

$$t ( x ) = {t}_{0} + \frac{x}{v} \qquad ( 1 )$$

where: t₀ is the reference time of the event; and v is the velocity of the event. The hyperbolic event may be represented by formula (2):

$$t ( x ) = \sqrt{{t}_{0}^{2} + {( \frac{x}{v} )}^{2}} \qquad ( 2 )$$

wherein: t₀ is the reference time of the event; and v is the velocity of the event.

The respective amplitude of the wavelet of at least one event of the one or more events may include an amplitude variation. The amplitude variation may be a monotonically decreasing amplitude or a monotonically increasing amplitude. There is about a 15% chance the amplitude variation may include the monotonically decreasing amplitude. There is about a 15% chance the amplitude variation may include the monotonically increasing amplitude. The respective amplitude of the wavelet of at least one event of the one or more events may include an increased amplitude or a decreased amplitude at a respective center of the synthetic image of the one or more synthetic images.

The method 500 may also include generating a ground-truth dataset including one or more ground-truth synthetic images and based on the synthetic dataset and the input data, as at 506. The one or more ground-truth synthetic images may be based on the user defined inputs. The one or more ground-truth synthetic images may be based on the user-defined velocity range. The one or more events of each ground-truth synthetic image of the one or more ground-truth synthetic images may be within the user-defined velocity range. Generating the one or more ground-truth synthetic images from the one or more synthetic images may include filtering the one or more events of each synthetic image of the one or more synthetic images based on the user-defined velocity range to generate a corresponding ground-truth synthetic image of the one or more ground-truth synthetic images.

The method 500 may also include generating one or more training pairs based on the ground-truth dataset and the synthetic dataset, as at 508. Each synthetic image of the one or more synthetic images and the corresponding ground-truth synthetic image of the one or more ground-truth synthetic images generated therefrom may form a respective training pair of the one or more training pairs.

The method 500 may also include training a machine-learning (ML) model based on the one or more training pairs to provide a trained ML model, as at 510. For example, the method 500 may include training the ML model based on the synthetic dataset and the ground-truth dataset to provide a trained ML model. Training the ML model may include supervised learning based on the one or more training pairs. The ML model may be trained based on the one or more synthetic images of the synthetic dataset and the corresponding one or more ground-truth synthetic images of the ground-truth dataset. The ML model may be trained on the one or more training pairs. Each synthetic image of the one or more synthetic images may be an input for training the ML model. Each corresponding ground-truth synthetic image of the one or more ground-truth synthetic images may be a label for training the ML model.

Training the ML model may include providing the one or more synthetic images as an input to the ML model. Training the ML model may also include generating an output including one or more predicted images using the ML model and based on the one or more synthetic images. Training the ML model may also include comparing the one or more predicted images and the one or more ground-truth synthetic images to determine one or more respective loss values. The respective loss values may be determined pixel-by-pixel. The one or more loss values may be determined using a Smooth L1 loss function including a beta threshold of about 0.001. Training the ML model may also include producing the trained ML model based on the one or more respective loss values.

The method 500 may also include generating an output including processed seismic data using the trained ML model and based on the target dataset, as at 512. The processed seismic data may include one or more processed images. The processed seismic data output may indicate and/or include information relating to a geology of the area including, but not limited to, layering and structure, faults and fractures, geometric traps and stratigraphic features, time and depth to horizons, amplitude behavior, velocity information, imaging beneath complex geology, or the like, or any combination thereof. Generating the output including the processed seismic data may include applying the trained ML model to the one or more images of the seismic data of the target dataset to generate the one or more processed images. Generating the output including the processed seismic data may also include generating the output including the processed seismic data based on the one or more processed images. Generating the output may include combining the one or more processed images with one another.

The method 500 may also include displaying the output, as at 514. The method 500 may also include performing an action in response to generating the output or displaying the output. The action may include generating or transmitting a signal that recommends, instructs, or causes a physical action to occur. The physical action may include one or more of optimizing a trajectory of a wellbore drilling operation, conducting drilling operations, conducting an exploratory operation, utilizing the single-upscaled permeability model in a simulation model, designing a production strategy, designing a hydraulic fracturing strategy, conducting risk assessments, monitoring an integrity of a pipeline, varying the composition of the gas, varying the pressure of the gas, varying the temperature of the gas, varying a flow rate of the gas, actuating a valve in the pipeline, selecting where to drill a wellbore, drilling the wellbore, varying a weight and/or torque on a drill bit that is drilling the wellbore, determining a location and/or amount of hydrocarbons in a subsurface formation and then varying a drilling trajectory of the wellbore toward the hydrocarbons, varying a concentration and/or flow rate of a fluid pumped into the wellbore, or a combination thereof.

As discussed above, the processed seismic data output may indicate and/or include information relating to the geology of a region or area. In such cases, the physical action may particularly include updating field models that determine operations, optimizing a trajectory of a wellbore drilling operation, and varying a weight and/or torque on a drill bit that is drilling the wellbore.

In at least one embodiment, the method 500 may further include normalizing the one or more synthetic images, the one or more ground-truth synthetic images, or a combination thereof. The one or more synthetic images may be normalized by respective root-mean-square amplitudes thereof. The one or more ground-truth synthetic images may be normalized by the respective root-mean-square amplitudes of the one or more synthetic images.

### Exemplary Computing System

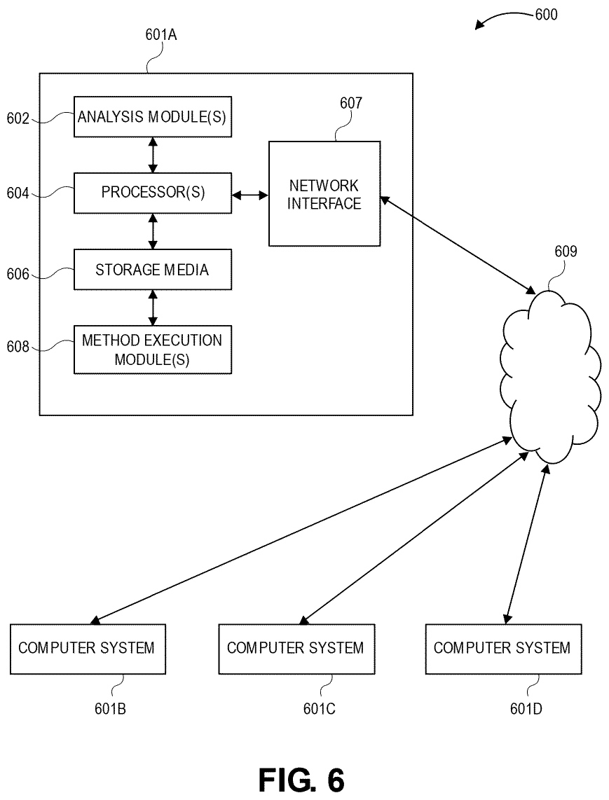

In some embodiments, the methods of the present disclosure may be executed by a computing system. FIG. 6 illustrates an example of such a computing system 600, in accordance with some embodiments. The computing system 600 may include a computer or computer system 601A, which may be an individual computer system 601A or an arrangement of distributed computer systems. The computer system 601A includes one or more analysis modules 602 that are configured to perform various tasks according to some embodiments, such as one or more methods disclosed herein. To perform these various tasks, the analysis module 602 executes independently, or in coordination with, one or more processors 604, which is (or are) connected to one or more storage media 606. The processor(s) 604 is (or are) also connected to a network interface 607 to allow the computer system 601A to communicate over a data network 609 with one or more additional computer systems and/or computing systems, such as 601B, 601C, and/or 601D (note that computer systems 601B, 601C and/or 601D may or may not share the same architecture as computer system 601A, and may be located in different physical locations, e.g., computer systems 601A and 601B may be located in a processing facility, while in communication with one or more computer systems such as 601C and/or 601D that are located in one or more data centers, and/or located in varying countries on different continents).

A processor may include a microprocessor, microcontroller, processor module or subsystem, programmable integrated circuit, programmable gate array, or another control or computing device.

The storage media 606 may be implemented as one or more computer-readable or machine-readable storage media. Note that while in the example embodiment of FIG. 6 storage media 606 is depicted as within computer system 601A, in some embodiments, storage media 606 may be distributed within and/or across multiple internal and/or external enclosures of computing system 601A and/or additional computing systems. Storage media 606 may include one or more different forms of memory including semiconductor memory devices such as dynamic or static random access memories (DRAMs or SRAMs), erasable and programmable read-only memories (EPROMs), electrically erasable and programmable read-only memories (EEPROMs) and flash memories, magnetic disks such as fixed, floppy and removable disks, other magnetic media including tape, optical media such as compact disks (CDs) or digital video disks (DVDs), BLURAY® disks, or other types of optical storage, or other types of storage devices. Note that the instructions discussed above may be provided on one computer-readable or machine-readable storage medium, or may be provided on multiple computer-readable or machine-readable storage media distributed in a large system having possibly plural nodes. Such computer-readable or machine-readable storage medium or media is (are) considered to be part of an article (or article of manufacture). An article or article of manufacture may refer to any manufactured single component or multiple components. The storage medium or media may be located either in the machine running the machine-readable instructions, or located at a remote site from which machine-readable instructions may be downloaded over a network for execution.

In some embodiments, computing system 600 contains one or more method execution module(s) 608. In the example of computing system 600, computer system 601A includes the method execution module 608. In some embodiments, a single method execution module may be used to perform some aspects of one or more embodiments of the methods disclosed herein. In other embodiments, a plurality of method execution modules may be used to perform some aspects of methods herein.

It should be appreciated that computing system 600 is merely one example of a computing system, and that computing system 600 may have more or fewer components than shown, may combine additional components not depicted in the example embodiment of FIG. 6, and/or computing system 600 may have a different configuration or arrangement of the components depicted in FIG. 6. The various components shown in FIG. 6 may be implemented in hardware, software, or a combination of both hardware and software, including one or more signal processing and/or application specific integrated circuits.

Further, the steps in the processing methods described herein may be implemented by running one or more functional modules in information processing apparatus such as general-purpose processors or application specific chips, such as ASICs, FPGAs, PLDs, or other appropriate devices. These modules, combinations of these modules, and/or their combination with general hardware are included within the scope of the present disclosure.

Computational interpretations, models, and/or other interpretation aids may be refined in an iterative fashion; this concept is applicable to the methods discussed herein. This may include use of feedback loops executed on an algorithmic basis, such as at a computing device (e.g., computing system 600, FIG. 6), and/or through manual control by a user who may make determinations regarding whether a given step, action, template, model, or set of curves has become sufficiently accurate for the evaluation of the subsurface three-dimensional geologic formation under consideration.

The foregoing description, for purpose of explanation, has been described with reference to specific embodiments. However, the illustrative discussions above are not intended to be exhaustive or limiting to the precise forms disclosed. Many modifications and variations are possible in view of the above teachings. Moreover, the order in which the elements of the methods described herein are illustrated and described may be re-arranged, and/or two or more elements may occur simultaneously. The embodiments were chosen and described in order to best explain the principles of the disclosure and its practical applications, to thereby enable others skilled in the art to best utilize the disclosed embodiments and various embodiments with various modifications as are suited to the particular use contemplated.

What is claimed is:

1. A method for training a machine-learning (ML) model for processing seismic data, the method comprising:
obtaining input data comprising a target dataset and user-defined inputs, wherein the target dataset comprises the seismic data;
generating a synthetic dataset comprising synthetic seismic data based on the seismic data of the target dataset;
generating a ground-truth dataset based on the synthetic dataset and the user-defined inputs;
generating one or more training pairs based on the ground-truth dataset and the synthetic dataset; and
training the machine-learning (ML) model based on the one or more training pairs to generate a trained ML model.

2. The method of claim 1, wherein the seismic data of the target dataset comprises one or more target seismic images, and wherein generating the synthetic dataset comprises generating one or more synthetic seismic images based on the one or more target seismic images.

3. The method of claim 2, wherein each target seismic image of the one or more target seismic images comprises a respective spatial sampling value and a respective temporal sampling value, and wherein a respective size and a respective resolution of each synthetic seismic image of the one or more synthetic seismic images is based on the respective spatial sampling and the respective temporal sampling of each target seismic image of the one or more target seismic images.

4. The method of claim 2, wherein each synthetic seismic image of the one or more synthetic seismic images comprises one or more events.

5. The method of claim 4, wherein each event of the one or more events is represented by a wavelet, and wherein the wavelet of each event of the one or more events is based on a delta function, a Ricker wavelet, or a Gaussian enveloped sinusoidal function.

6. The method of claim 4, wherein each event of the one or more events comprises a respective velocity, and wherein the respective velocity of each event of the one or more events is based on a dip angle thereof.

7. The method of claim 4, wherein each event of the one or more events comprises a linear moveout or a hyperbolic moveout.

8. The method of claim 2, wherein the user-defined inputs comprise a user-defined velocity range, and wherein generating the ground-truth dataset comprises generating one or more ground-truth synthetic seismic images using the one or more synthetic seismic images of the synthetic seismic data and based on the user-defined velocity range.

9. The method of claim 1, further comprising generating an output using the trained ML model and based on the seismic data.

10. The method of claim 9, further comprising performing an action in response to generating the output, wherein the action comprises generating or transmitting a signal that recommends, instructs, or causes a physical action to occur, wherein the physical action comprises one or more of optimizing a trajectory of a wellbore drilling operation, conducting drilling operations, conducting an exploratory operation, utilizing a single-upscaled permeability model in a simulation model, designing a production strategy, designing a hydraulic fracturing strategy, conducting risk assessments, monitoring an integrity of a pipeline, or any combination thereof.

11. A computing system, comprising:
one or more processors; and
a memory system comprising one or more non-transitory computer-readable media storing instructions that, when executed by at least one of the one or more processors, cause the computing system to perform operations for training a machine-learning (ML) model for processing seismic data, the operations comprising:
obtaining input data comprising a target dataset and user-defined inputs, wherein the target dataset comprises the seismic data;
generating a synthetic dataset comprising synthetic seismic data based on the seismic data of the target datasets;
generating a ground-truth dataset based on the synthetic dataset and the user-defined inputs;
generating one or more training pairs based on the ground-truth dataset and the synthetic dataset; and
training the machine-learning (ML) model based on the one or more training pairs to generate a trained ML model.

12. The computing system of claim 11, wherein:
the seismic data of the target dataset comprises one or more target seismic images;
generating the synthetic dataset comprises generating one or more synthetic seismic images based on the one or more target seismic images, wherein each synthetic seismic image of the one or more synthetic seismic images comprises one or more events, and wherein each event of the one or more events is represented by a wavelet.

13. The computing system of claim 12, wherein the wavelet of each event of the one or more events comprises an amplitude, wherein the amplitude of the wavelet comprises a uniform distribution over a logarithmic space having a basis of 10, and wherein the amplitude comprises a range of from about 0.001 to about 1.

14. The computing system of claim 12, wherein the wavelet of each event of the one or more events comprises a phase rotation, wherein the phase rotation comprises a uniform distribution over a linear space of each synthetic seismic image of the one or more synthetic seismic images, and wherein the phase rotation comprises a range of from about 0 to about pi (π).

15. The computing system of claim 12, wherein the wavelet of each event of the one or more events is band-passed by a band-pass range comprising a low-cut frequency and a high-cut frequency, wherein the low-cut frequency is from the Rayleigh frequency to ½ of the Nyquist frequency of a respective synthetic time window of each synthetic seismic image of the one or more synthetic seismic images, and wherein the high-cut frequency is from the low-cut frequency to the Nyquist frequency of the respective synthetic time window of each synthetic seismic image of the one or more synthetic seismic images.

16. A non-transitory computer-readable medium storing instructions that, when executed by one or more processors of a computing system, cause the computing system to perform operations for training a machine-learning (ML) model for processing seismic data, the operations comprising:
obtaining input data comprising a target dataset and user-defined inputs, wherein the target dataset comprises the seismic data;
generating a synthetic dataset comprising synthetic seismic data based on the seismic data of the target datasets;
generating a ground-truth dataset based on the synthetic dataset and the user-defined inputs;
generating one or more training pairs based on the ground-truth dataset and the synthetic dataset; and
training the machine-learning (ML) model based on the one or more training pairs to generate a trained ML model.

17. The non-transitory computer-readable medium of claim 16, wherein:
the seismic data of the target dataset comprises one or more target seismic images;
generating the synthetic dataset comprises generating one or more synthetic seismic images based on the one or more target seismic images, wherein each synthetic seismic image of the one or more synthetic seismic images comprises one or more events, wherein each event of the one or more events is represented by a wavelet, wherein the wavelet of each event of the one or more events comprises:
an amplitude, wherein the amplitude of the wavelet comprises a uniform distribution over a logarithmic space having a basis of 10; and
a phase rotation, wherein the phase rotation comprises a uniform distribution over a linear space of each synthetic seismic image of the one or more synthetic seismic images.

18. The non-transitory computer-readable medium of claim 17, wherein the wavelet of each event of the one or more events is based on a delta function, a Ricker wavelet, or a Gaussian enveloped sinusoidal function, wherein:
the Ricker wavelet of each synthetic seismic image of the one or more synthetic seismic images comprises a central frequency based on a respective synthetic time window of the synthetic seismic image; and
the Gaussian enveloped sinusoidal function is based on a combination of a Gaussian function and a sinusoidal function.

19. The non-transitory computer-readable medium of claim 17, wherein generating the ground-truth dataset comprises generating one or more ground-truth synthetic seismic images using the one or more synthetic seismic images and based on the user-defined inputs, wherein the user-defined inputs comprise a user-defined velocity range, and wherein generating the one or more ground-truth synthetic seismic images comprises:
filtering the one or more events of each synthetic seismic image of the one or more synthetic seismic images based on the user-defined velocity range to generate a corresponding ground-truth synthetic seismic image of the one or more ground-truth synthetic seismic images.

20. The non-transitory computer-readable medium of claim 19, wherein each training pair of the one or more training pairs comprises each synthetic seismic image of the one or more synthetic seismic images and the corresponding ground-truth synthetic seismic image of the one or more ground-truth synthetic seismic images, and wherein training the ML model based on the one or more training pairs comprises:
providing the one or more synthetic seismic images as an input to the ML model;
generating one or more predicted images using the ML model and based on the one or more synthetic seismic images;
comparing the one or more predicted images and the one or more ground-truth synthetic seismic images to determine one or more loss values; and
generating the trained ML model based on the one or more loss values.
